(19) United States
(12) Patent Application Publication
(10) Pub. No.: US 2025/0156175 A1
(43) Pub. Date: May 15, 2025

(54) SOFTWARE UPDATE SYSTEM AND SOFTWARE UPDATE METHOD

(71) Applicant: Mitsubishi Electric Corporation, Chiyoda-ku, Tokyo (JP)

(72) Inventor: Takashi HATTORI, Tokyo (JP)

(73) Assignee: Mitsubishi Electric Corporation, Chiyoda-ku, Tokyo (JP)

(21) Appl. No.: 18/836,027

(22) PCT Filed: Feb. 24, 2022
(86) PCT No.: PCT/JP2022/007534

§ 371 Date: Aug. 6, 2024

(51) Int. Cl. G06F 8/65; G06F 8/52

(52) U.S. Cl. CPC G06F 8/65; G06F 8/52

(57) ABSTRACT

It is an object of the present disclosure to provide a software update system and a software update method capable of safely performing an update at a low cost while saving resources. A software update system according to the present disclosure includes an update software generation device and a CPU, the update software generation device includes a stored address translation unit that translates a stored address stored in a memory on the CPU allocated per at least one instruction code of an assembler code or a machine language code of update software into a different stored address from a normal stored address, and the CPU includes a stored address inverse translation unit that returns the different stored address resulting from the translation by the stored address translation unit to the normal stored address.

### TECHNICAL FIELD

The present disclosure relates to a software update system and a software update method to update software for use in a microcomputer or a central processing unit (CPU).

### BACKGROUND ART

With the development of the Internet of things (IoT) technology, a household electrical appliance having conventionally been used alone is provided with a communication feature and is connected to the Internet, so that the household electrical appliance can be operated or an operating status of the household electrical appliance can be checked on the go by means of a smartphone. A microcomputer or a CPU (hereinafter collectively referred to as the “CPU”) for an embedded device used for control of the household electrical appliance can be a target of a computer virus as with a CPU for a personal computer, a smartphone, or a tablet terminal. A software update is thus necessary not only to improve a feature of application software for household electrical appliance control running on a CPU itself but also to avoid vulnerability found in driver software to achieve a communication feature operating on a CPU mounted on a household electrical appliance, an operating system (OS) to operate a group of software (including that referred to as firmware) including the above-mentioned control application software, or software such as a boot loader.

On the other hand, a CPU for use in a household electrical appliance or a control board for household electrical appliance control on which the CPU is mounted has been generalized as in a case of a personal computer, so that it is easy to copy such hardware for manufacture. When having a price competitiveness enabling inexpensive manufacture of hardware and having access to application software for control without development, late-coming manufacturers can devote their resources for development of application software for control having higher added value and are thus advantageous in a market of the household electrical appliance. It is thus necessary to protect application software for control to increase the added value of the household electrical appliance to thereby maintain the price of the household electrical appliance against theft or reverse engineering by a third party. Measures against theft, piracy, and reverse engineering of software are important not only for the household electrical appliance but also for all embedded devices having software update features.

Even when having a low processing power, a CPU for use in an embedded device generally has a feature of prohibiting reading of software stored in a nonvolatile region, such as a flash memory, in the CPU by being externally connected to a debugger and the like as shown in Non-Patent Document 1 (FIG. 2.11 on page 33), for example. It is thus difficult to read or copy the software in the CPU by disassembly of a commercially available embedded device, and there is a low risk of theft or piracy of the software by disassembly.

As for an IoT device, software in the IoT device is updated from an update file server on a wide area network, such as the Internet, via a communication gateway as shown in Non-Patent Document 2 (FIG. 1 on page 12), for example. In this case, an update file in a hashed or signed encrypted data format is used to ensure confidentiality and integrity of the updated software as shown in Non-Patent Document 2 (Table 1 on page 10). A CPU in the IoT device is required to verify hash or a signature and to decrypt and develop the update file into an update image to install the update file.

When the update file server on the Internet is not used, it is contemplated to use an encryption feature provided as a utility program of a commercially available jig (Flash Programmer) to write software into a CPU as shown in Non-Patent Document 3, for example. In this case, decryption processing is performed on a personal computer that operates the commercially available jig, so that there is an advantage that a CPU for use in an embedded device, such as the IoT device, is not required to have memory resources and a processing power to perform the decryption processing.

For example, Patent Document 1 discloses a communication scheme when a personal computer is used to update software in a peripheral device of the personal computer with Motorola S data.

For example, Patent Document 2 discloses a system to transmit software to which a redundant processing code for encryption has been added in a state of a source code of the software per personal computer of a client via a communication line.

### PRIOR ART DOCUMENTS

### Patent Documents

Patent Document 1: Japanese Patent Application Laid-Open No. 2007-219915
Patent Document 2: Japanese Patent Application Laid-Open No. 2005-266887

### Non-Patent Documents

Non-Patent Document 1: Renesas Electronics Corporation, “Renesas Flash Programmer V3.08 Flash Writing Software User's Manual”, Rev. 3.00, July 2021
Non-Patent Document 2: Connected Consumer Device Security Council, “IoT Device Security Implementation Guideline Software Update Feature”, Edition 1.0, Dec. 1, 2020
Non-Patent Document 3: “Renesas Flash Programmer (Programming GUI) Renesas Flash Programmer V3”, [online], Renesas Electronics Corporation, [Searched on Jan. 11, 2022], Internet <URL: https://www.renesas.com/jp/ja/software-tool/renesas-flash-programmer-programming-gui#code>

### SUMMARY

### Problem to be Solved by the Invention

In Non-Patent Document 1, when the software is required to be updated, the updated software might be thieved or pirated while being on a communication path or through manual intervention as an update file, so that it is necessary to avoid theft and piracy.

Non-Patent Document 2 ((10) on page 13) discloses that the communication gateway is sometimes responsible for part of processing to update the software in a use case in which the IoT device has a low processing performance, but the communication gateway is sometimes manufactured by a different manufacturer from the IoT device targeted for an update of software, so that it is assumed that confidentiality and integrity cannot be ensured. The CPU for use in the embedded device, such as the IoT device, often has insufficient memory resources and an insufficient processing power to perform verification of the signature and decryption processing, and use of a high performance CPU is likely to cause an increase in cost of a product.

In Non-Patent Document 3, a maintenance service worker who carries a commercially available jig and a work terminal, such as a personal computer, is dispatched to a place where an IoT product is installed, or a work is entrusted to an operator who configures or operates an entire system including the IoT device, so that sharing, distribution, and management of a password are necessary. It is thus difficult to ensure confidentiality, and these measures are not sufficient as measures against theft or piracy of update software.

It is an object of Patent Document 1 to detect an absence of a data record of the Motorola S data on a communication path and to make it difficult to find a method of calculating a sum value prepared per record to enhance measures against tampering, so that an address, an instruction code, or a data operand in the data record itself remains unchanged. Software can thus be used only by adding an original sum value of the Motorola S data again, so that these measures cannot be the measures against theft, piracy, or reverse engineering.

In Patent Document 2, some efforts are required for decryption in terms of reverse engineering, but the software can be used and operated as it is even when redundant processing has been added, so that these measures cannot be the measures against theft or piracy.

The present disclosure has been conceived to solve such problems, and it is an object of the present disclosure to provide a software update system and a software update method capable of safely performing an update at a low cost while saving resources.

### Means to Solve the Problem

To solve the above-mentioned problems, a software update system according to the present disclosure is a software update system including an update software generation device and a central processing unit (CPU), the update software generation device generating update software to update software running on the CPU, the CPU updating the software using the update software generated by the update software generation device, wherein the update software generation device includes a stored address translation unit that translates a stored address stored in a memory on the CPU allocated per at least one instruction code of an assembler code or a machine language code of the update software or a stored address stored in the memory allocated per data in a data region defined at least by a constant and a structure in the update software into a different stored address from a normal stored address, and the CPU includes a stored address inverse translation unit that returns the different stored address resulting from the translation by the stored address translation unit to the normal stored address.

### Effects of the Invention

According to the present disclosure, an update can safely be performed at a low cost while saving resources.

These and other objects, features, aspects and advantages of the present disclosure will become more apparent from the following detailed description when taken in conjunction with the accompanying drawings.

### BRIEF DESCRIPTION OF DRAWINGS

FIG. 1 is a block diagram showing one example of a configuration of a software update system according to Embodiment 1.

FIG. 2 is a diagram showing one example of translation of stored addresses by a stored address translation unit according to Embodiment 1.

FIG. 3 is a diagram showing one example of insertion of pseudo-codes by a pseudo-code insertion unit according to Embodiment 1.

FIG. 4 is a diagram showing one example of translation of register numbers by a register number translation unit according to Embodiment 1.

FIG. 5 is a diagram showing one example of translation of operand addresses by an operand address translation unit according to Embodiment 1.

FIG. 6 is a diagram showing one example of translation of data by a data translation unit according to Embodiment 1.

FIG. 7 is a block diagram showing one example of a configuration of a software update system according to Embodiment 2.

FIG. 8 is a diagram showing one example of a hardware configuration of each of the software update systems according to Embodiments 1 and 2.

FIG. 9 is a diagram showing one example of the hardware configuration of each of the software update systems according to Embodiments 1 and 2.

### DESCRIPTION OF EMBODIMENTS

### Embodiment 1

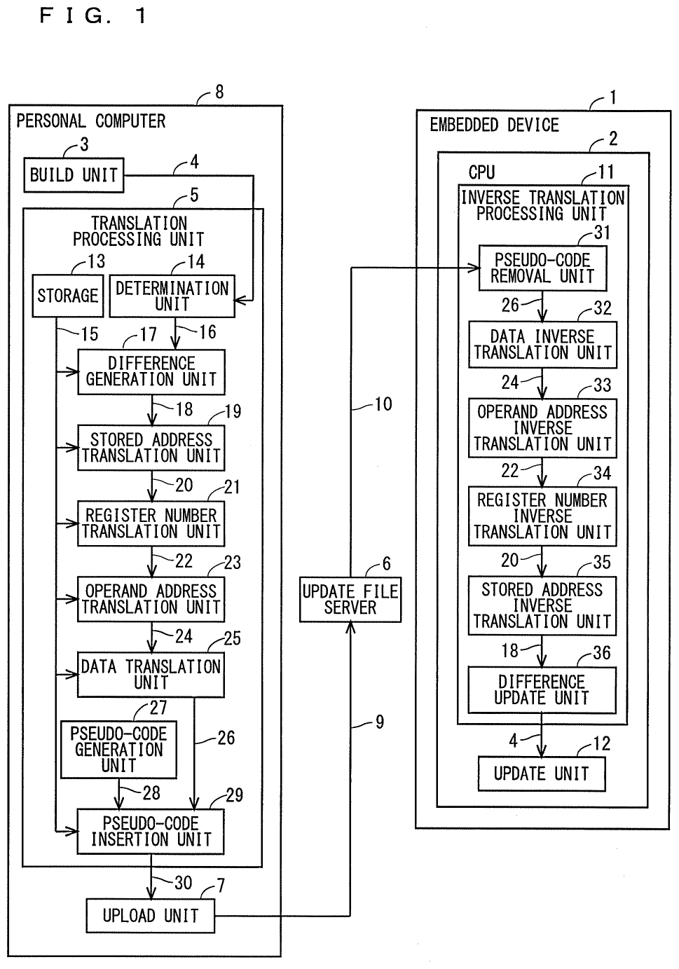

FIG. 1 is a block diagram showing one example of a configuration of a software update system according to Embodiment 1.

As shown in FIG. 1, the software update system includes an embedded device 1, a personal computer 8 (an update software generation device), and an update file server 6. The personal computer 8 and the update file server 6 are connected via an upload path 9. The embedded device 1 and the update file server 6 are connected via a download path 10. The upload path 9 and the download path 10 are over the Internet. The update file server 6 is a server to distribute update software 30 to the embedded device 1.

### <Personal Computer 8>

The personal computer 8 includes a build unit 3, a translation processing unit 5, and an upload unit 7.

The build unit 3 performs processing such as compilation and linkage of source codes of software to be updated.

The upload unit 7 uploads software after translation processing (the update software 30) generated by the translation processing unit 5 to the update file server 6 via the upload path 9.

The translation processing unit 5 includes a storage 13, a determination unit 14, a difference generation unit 17, a stored address translation unit 19, a register number translation unit 21, an operand address translation unit 23, a data translation unit 25, a pseudo-code generation unit 27, and a pseudo-code insertion unit 29.

The storage 13 stores current processing according to an inverse translation processing unit 11 of a CPU 2 or information on a program and a function (current inverse translation information 15). The determination unit 14 determines an update (new processing, next inverse translation information 16) performed by the inverse translation processing unit 11 itself when the next software update is performed.

The difference generation unit 17 generates, from a difference between the current inverse translation information 15 stored in the storage 13 and the next inverse translation information 16 determined by the determination unit 14, difference update software that is software to partially update only the difference of processing performed by the inverse translation processing unit 11. The difference generation unit 17 merges the generated software into update software 4 generated by the build unit 3. The difference generation unit 17 outputs update software 18 after merging to the stored address translation unit 19.

The stored address translation unit 19 translates a stored address in the update software 18 so that the stored address is restored to an original stored address when being inverse translated according to the current inverse translation information 15. Specifically, the stored address translation unit 19 translates a stored address stored in a memory on the CPU 2 allocated per at least one instruction code of an assembler code or a machine language code of the update software 18 or a stored address stored in the memory allocated per data in a data region defined at least by a constant and a structure in the update software 18 into a different stored address from a normal stored address. The stored address translation unit 19 outputs update software 20 after the translation of the stored address to the register number translation unit 21.

The register number translation unit 21 translates a register number in the update software 20 so that the register number in an instruction code is restored to an original register number when being inverse translated according to the current inverse translation information 15. Specifically, the register number translation unit 21 translates a register number of a general-purpose register or a floating point register for use in an instruction code of an assembler code or a machine language code of the update software 20 into a register number usable by the CPU. The register number translation unit 21 outputs update software 22 after the translation of the register number to the operand address translation unit 23.

The operand address translation unit 23 translates an operand address or immediate data in the update software 22 so that the operand address or the immediate data in an instruction code is restored to an original operand address or original immediate data when being inverse translated according to the current inverse translation information 15. Specifically, the operand address translation unit 23 translates an operand address or immediate data for use in an instruction code of an assembler code or a machine language code of the update software 22. The operand address translation unit 23 outputs update software 24 after the translation of the operand address or the immediate data to the data translation unit 25.

The data translation unit 25 translates a value of each piece of data in a data region defined by a constant, a structure, and the like in the update software 24 so that the value of the data in the data region is restored to an original value of the data when being inverse translated according to the current inverse translation information 15. Specifically, the data translation unit 25 translates a value of each piece of data in the data region defined at least by the constant and the structure in the update software 24. The data translation unit 25 outputs update software 26 after the translation of the value of the data to the pseudo-code insertion unit 29.

The pseudo-code generation unit 27 generates an instruction code or any data string as a pseudo-code. The pseudo-code generation unit 27 outputs the generated pseudo-code 28 to the pseudo-code insertion unit 29. Specifically, the pseudo-code generation unit 27 generates an instruction code or a data string of an assembler code or a machine language code of the update software as the pseudo-code.

The pseudo-code insertion unit 29 inserts the pseudo-code 28 into an unused stored address in the update software 26. Specifically, the pseudo-code insertion unit 29 inserts the pseudo-code 28 generated by the pseudo-code generation unit 27 into the unused stored address in the update software 26 or into a stored address that is no longer used by being translated into a different stored address by the stored address translation unit 19. The pseudo-code insertion unit 29 outputs the update software 30 after the insertion of the pseudo-code 28 to the upload unit 7.

### <Embedded Device 1>

The embedded device 1 includes the CPU 2. The CPU 2 includes the inverse translation processing unit 11 and an update unit 12. The embedded device 1 is targeted for an update of software. The CPU 2 is one of components constituting the embedded device 1, and a memory (not shown) that stores a sequence of instructions constituting a program, a function, and the like in the software or data processed by the software is implemented in the same chip. The inverse translation processing unit 11 performs inverse translation of the translation processing performed by the translation processing unit 5 to restore the update software 4 before the translation processing. The update unit 12 updates software for use in the CPU 2 using the update software 4 restored by the inverse translation processing unit 11.

The inverse translation processing unit 11 includes a pseudo-code removal unit 31, a data inverse translation unit 32, an operand address inverse translation unit 33, a register number inverse translation unit 34, a stored address inverse translation unit 35, and a difference update unit 36.

The pseudo-code removal unit 31 removes all the pseudo-code 28 inserted by the pseudo-code insertion unit 29 from the update software 30 downloaded from the update file server 6 via the download path 10. The pseudo-code removal unit 31 outputs the update software 26 after the removal of the pseudo-code 28 to the data inverse translation unit 32. The update software 26 output from the pseudo-code removal unit 31 corresponds to the update software 26 output from the data translation unit 25.

The data inverse translation unit 32 performs inverse translation of the translation by the data translation unit 25 on the update software 26 restored by the pseudo-code removal unit 31 to restore the value of the data in the data region. The data inverse translation unit 32 outputs the update software 24 after the restoration of the value of the data to the operand address inverse translation unit 33. The update software 24 output from the data inverse translation unit 32 corresponds to the update software 24 output from the operand address translation unit 23.

The operand address inverse translation unit 33 performs inverse translation of the translation by the operand address translation unit 23 on the update software 24 restored by the data inverse translation unit 32 to restore the operand address or the immediate data. The operand address inverse translation unit 33 outputs the update software 22 after the restoration of the operand address or the immediate data to the register number inverse translation unit 34. The update software 22 output from the operand address inverse translation unit 33 corresponds to the update software 22 output from the register number translation unit 21.

The register number inverse translation unit 34 performs inverse translation of the translation by the register number translation unit 21 on the update software 22 restored by the operand address inverse translation unit 33 to restore the register number. The register number inverse translation unit 34 outputs the update software 20 after the restoration of the register number to the stored address inverse translation unit 35. The update software 20 output from the register number inverse translation unit 34 corresponds to the update software 20 output from the stored address translation unit 19.

The stored address inverse translation unit 35 performs inverse translation of the translation by the stored address translation unit 19 on the update software 20 restored by the register number inverse translation unit 34 to restore the stored address. The stored address inverse translation unit 35 outputs the update software 18 after the restoration of the stored address to the difference update unit 36. The update software 18 output from the stored address inverse translation unit 35 corresponds to the update software 18 output from the difference generation unit 17.

The difference update unit 36 extracts and removes the difference update software merged by the difference generation unit 17 to generate the update software 4 that is exactly the same update software as the update software 4 generated by the build unit 3.

The update unit 12 updates the inverse translation processing unit 11 itself (updates the software for use in the CPU 2) upon completion of the processing performed by the inverse translation processing unit 11 required for this software update.

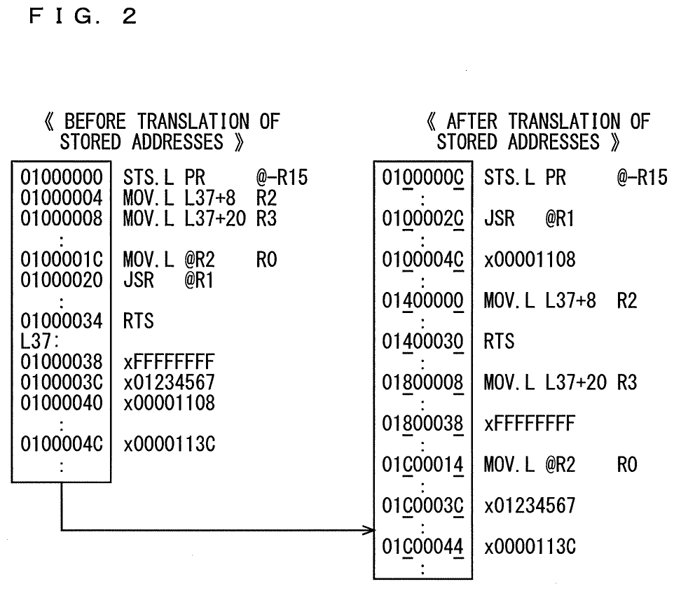

FIG. 2 is a diagram showing one example of translation of stored addresses by the stored address translation unit 19.

As shown in FIG. 2, before and after the translation of the stored addresses, address values represented by eight-digit HEX values are translated and arranged in ascending order (see portions enclosed by solid lines in the figure). As a rule of the translation of the stored addresses, for example, a value of the third digit from the left and a value of the least significant digit at the right end are replaced with each other based on the assumption that the third digit from the left is not used in each stored address after the translation, and values 0, 4, 8, and C of the least significant digit as values for a four-byte boundary are respectively translated into C, 0, 8, and 4. In this case, in each stored address after the translation, the restoration can be performed by replacing the value of the least significant digit and the value of the third digit from the left with each other and then replacing the value of the third digit from the left with 0.

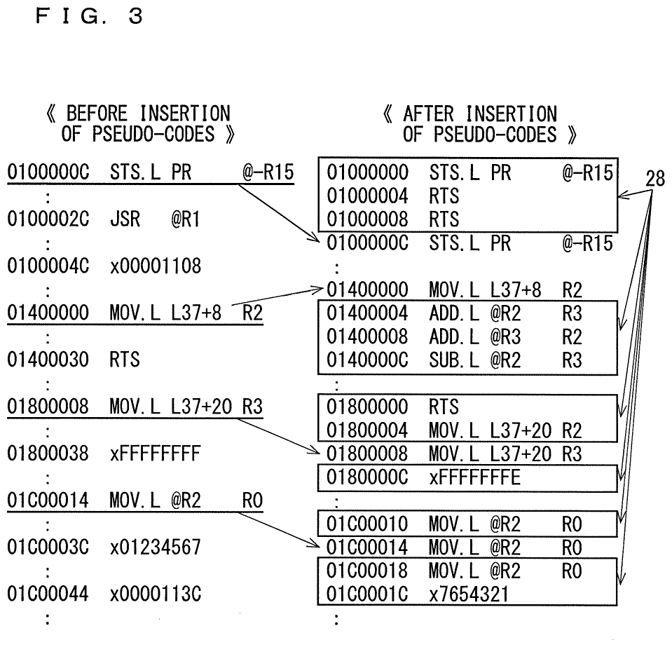

FIG. 3 is a diagram showing one example of insertion of pseudo-codes by the pseudo-code insertion unit 29. As for location addresses 0100002C, 0100004C, 01400030, 01800038, 01C0003C, and 01C00044 before the insertion of the pseudo-codes, examples of the location addresses after the insertion of the pseudo-codes are not shown.

FIG. 3 shows an example of a rule of insertion of pseudo-codes having addresses whose least significant digits are 0, 4, and 8 when the third digit from the left is 0 because the least significant digit is only C and is not 0, 4, and 8 in this case in the example of FIG. 2. Similarly, pseudo-codes having addresses whose least significant digits are 4, 8, and C are inserted when the third digit from the left is 4, pseudo-codes having addresses whose least significant digits are 0, 4, and C are inserted when the third digit from the left is 8, and pseudo-codes having addresses whose least significant digits are 0, 8, and C are inserted when the third digit from the left is C. In a case of the example of FIG. 3, it is only necessary to remove the least significant digits other than C when the value of the third digit is 0, remove the least significant digits other than 0 when the value of the third digit is 4, remove the least significant digits other than 8 when the value of the third digit is 8, and remove the least significant digits other than 4 when the value of the third digit is C.

When the translation by the stored address translation unit 19 is performed first, an STS instruction indicating a start of a function or an RTS instruction indicating an end of a function can be used as pseudo-codes as appropriate to make it difficult to know the number of functions in the update software. When the translation by the stored address translation unit 19 is performed later, a plurality of functions that perform meaningless operation in the embedded device 1 may be stored as pseudo-codes in unused regions in the update software 4.

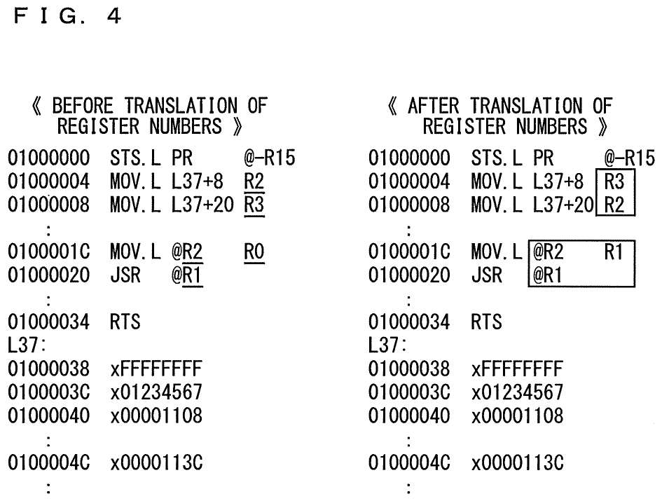

FIG. 4 is a diagram showing one example of translation of register numbers by the register number translation unit 21.

In the example of FIG. 4, general-purpose registers R0, R2, and R3 are respectively translated into R1, R3, and R2. As a rule of the translation, however, values stored in general-purpose registers themselves, such as “@R2” and “@R1”, are not used for execution of instructions, and no translation is performed when the values stored in the general-purpose registers are referred to as addresses. In a case of the example of FIG. 4, restoration can be performed by returning R3 to R2 and R2 to R3.

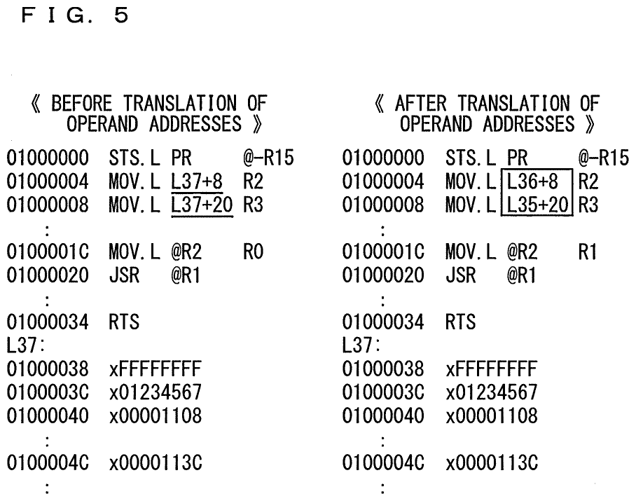

FIG. 5 is a diagram showing one example of translation of operand addresses by the operand address translation unit 23.

In an example of FIG. 5, a label “L37” can be determined as a base address of a stack region of this function and is thus translated into a base address other than L37. In the example of FIG. 5, L37 is not known when the stored address is translated by the stored address translation unit 19 but is known and thus can be restored when the stored address is restored by the stored address inverse translation unit 35.

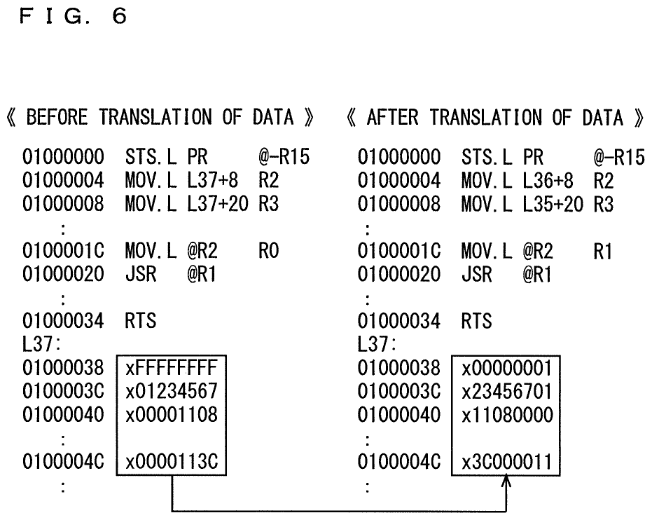

FIG. 6 is a diagram showing one example of translation of data by the data translation unit 25.

In an example of FIG. 6, when a constant value in the stack region is −1(FFFFFFFF), the constant value is translated into +1(00000001), and the other values are translated by viewing addresses in the stack region in ascending order and left rotating the addresses in units of eight bits. In a case of the example of FIG. 6, restoration can be performed by translating +1 into −1 and right rotating the addresses in units of eight bits.

### Modifications

While a case of an assembler code has been described above, similar processing can be performed on an assembler code having been translated into a machine language code or a machine language code having been translated into that in a data format for writing into the CPU 2, such as the Motorola S data. The format for writing into the CPU 2 is only required to meet the specifications of the CPU 2 and is not limited to the Motorola S data.

While a case where the translation processing unit 5 performs processing on the personal computer 8 has been described above, the processing may not be performed on the personal computer 8.

While an example in which processing of the register number translation unit 21, processing of the operand address translation unit 23, processing of the data translation unit 25, and processing of the pseudo-code insertion unit 29 are performed after processing of the stored address translation unit 19 has been described above, the processing of these units may be performed before the processing of the stored address translation unit 19. The processing of these units may be performed in any combination or in any order, and, for example, translation or inverse translation processing of one or more of these units may be performed before the processing of the stored address translation unit 19 or may not be performed. However, when register numbers are translated while taking values of register numbers in preceding and succeeding instruction codes into consideration as a rule of the translation, for example, arrangement of the preceding and succeeding instruction codes changes before and after the processing of the stored address translation unit 19, so that it is necessary to accordingly change an order in which processing of the pseudo-code removal unit 31, processing of the data inverse translation unit 32, processing of the operand address inverse translation unit 33, processing of the register number inverse translation unit 34, and processing of the stored address inverse translation unit 35 of the inverse translation processing unit 11 that performs processing on the CPU 2 are performed.

While a case where the processing of the inverse translation processing unit 11 is performed in a series of software update processes has been described above, the processing of the inverse translation processing unit 11 may be performed in a boot loader that operates when power is on or may be performed while returning an order to that before the translation immediately before actual execution of the software on the CPU 2. The rule of the translation or the inverse translation may be changed depending on a type of software, such as an OS, a boot loader, a program to perform the inverse translation, a function, and application software. Some patterns of an inverse translation function may be prepared, and the rule of the translation or the inverse translation may be changed in midstream according to a predetermined rule.

While a case where the number of update file servers 6 is one has been shown in FIG. 1, a plurality of update file servers 6 may be installed for load distribution. The processing of the pseudo-code removal unit 31 may be performed by determining a rule of a communication channel or a port number to transmit a pseudo-code in advance and discarding data of update software transmitted on a particular communication channel or with a particular port number, for example.

While a configuration in which software executed by the CPU and a memory that stores data processed by the software are implemented in the same chip as the CPU has been described as one example, the configuration is not limited to this configuration. For example, the configuration may be a configuration in which, in a CPU implemented as a CPU core in a field programmable gate array (FPGA), a memory that stores software and data are implemented in the same FPGA chip, for example.

### Effects

As described above, even when the update software 30 downloaded from the update file server 6 by the embedded device 1 cannot be used as it is, the inverse translation processing unit 11 performs the inverse translation of the update software 30 on the CPU 2 according to a rule known only by a designer to restore the update software 4, so that an update can safely be performed at a low cost while saving resources.

A software update has conventionally been performed by the embedded device 1 by uploading the update software 4 generated by the build unit 3 to the update file server 6 and downloading the uploaded update software 4 from a side of the embedded device 1. The upload path 9 is over the Internet, so that uploading between the upload unit 7 on the personal computer 8 and the update file server 6 has conventionally been protected by secure sockets layer (SSL)/transport layer security (TLS) and the like to prevent theft, tampering, and reverse engineering of software on the communication path.

In contrast, in Embodiment 1, the translation processing unit 5 translates stored addresses on the CPU 2, register numbers, operand addresses or immediate data, and a value of each piece of data in the data region in the update software 4 according to the rule known only by the designer of the software, and the CPU 2 performs the software update using the update software 4 restored by the inverse translation processing unit 11 processed on the CPU 2 performing the inverse translation according to the rule known only by the designer. The stored addresses on the CPU 2, the register numbers, the operand addresses or the immediate data, and the value of the data in the data region have been translated, so that they cannot be used as they are even when thieved on the communication path. The CPU 2 on the embedded device 1 is thus not required to perform verification of a signature and decryption processing required for the SSL/TLS. Restoration without knowing the rule of the translation/inverse translation is not easy, so that even a CPU for an embedded device having limited memory resources and a limited processing power can perform the restoration, and this method is an effective method as measures to prevent reverse engineering.

A code for tampering detection and a method of calculating the code are also translated/inverse translated according to the rule known only by the designer to make identification thereof difficult, so that tampering is easily detected using an easy checksum without calculating a hash value to achieve prevention of tampering.

In a case of the C language, software includes a combination of a plurality of functions. While a particular assembler instruction in each of the functions is used in a fixed manner at a call of the function or a return from the function, assembler instructions usable by the CPU are combined in a particular order in processing in the function to achieve a desired feature. In this case, even if assembler instructions used in a certain function are stored one by one in random order, it is easy to find a correct order of execution of the instructions from a number of a general-purpose register used in each of the assembler instructions and a configuration of a stack region used in each function, and the correct order of execution of the instructions can be found in a shorter time when a feature achieved by the function is known.

When the number of functions in entire software, features of the respective functions, the number of assembler instructions constituting each of the functions, a size of the stack region, and an order in which any pieces of data and address information are stored in the stack region are not known, however, it is difficult to correctly restore the functions one by one and correctly reproduce a configuration of the functions if the order is changed across the functions.

For example, if it is known that a function is a function of 10 lines and includes a combination of six instructions including overlapping instructions, there are 6¹⁰ combinations of an order of execution of the instructions for only one function. When encryption and decryption are performed, a correct answer is immediately known if keys match because an assembler code and a mot file cannot be recognized unless the keys match, but each assembler instruction correctly runs on the CPU, so that, when round-robin determination is made to find the correct answer, it is necessary to prepare an embedded device targeted for copying and write 6¹⁰ types of software into the embedded device for operation verification to find a correct order of execution of the instructions. While it is considered necessary to take time for actual operation verification because operation is contemplated to include operation close to the correct answer and the same operation as the correct answer under a certain condition, a period of 11 months is required assuming that it takes one second to verify operation of one pattern including time to write software, and the correct answer can be found after verification of operation of half of 6¹⁰ patterns due to parallel verification by a plurality of devices, for example.

A period of one year or more is contemplated to be required if it takes one or more seconds to verify operation, the function is a function of 10 or more lines, and the combination is a combination of six or more instructions. Software actually includes a plurality of functions, so that an effect of preventing use as it is and piracy or reverse engineering can be obtained without performing encryption and decryption processing or concealing the communication path by setting the rule of the translation/inverse translation known only by the designer of the software for a household electrical appliance whose new product is released every year.

### Embodiment 2

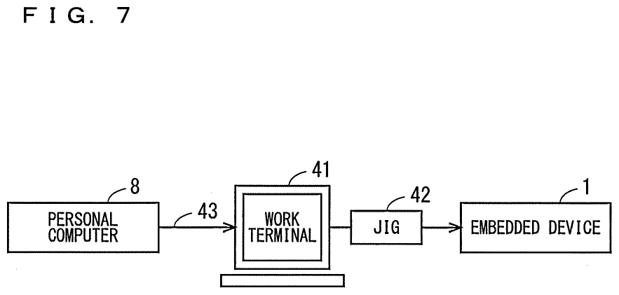

FIG. 7 is a block diagram showing one example of a configuration of a software update system according to Embodiment 2.

As shown in FIG. 7, a work terminal 41 is connected to the embedded device 1 via a jig 42. The embedded device 1 and the personal computer 8 shown in FIG. 7 are respectively the same as the embedded device 1 and the personal computer 8 shown in FIG. 1.

The work terminal 41 is a work terminal used by a maintenance service worker (not shown) who visits a site where the embedded device 1 is installed to update software.

The jig 42 is a jig to connect the embedded device 1 and the work terminal 41 and write the software into the CPU 2 in the embedded device 1.

A delivery path 43 is a path to deliver the update software 30 generated by the personal computer 8 to the work terminal 41.

The delivery path 43 is contemplated to include a path in a case of distribution over the Internet through attachment to an email and a path in a case of distribution via a medium, such as a universal serial bus (USB) memory, for example. The update software has thus conventionally been required to be encrypted to prepare for theft on the Internet or a loss of the USB memory. The encrypted software, however, is required to be decrypted on the work terminal, so that there are limitations to management of the decrypted update software.

In contrast, according to the present disclosure, the stored addresses on the CPU 2, the register numbers, the operand addresses or the immediate data, and the value of the data in the data region in the update software 30 generated by the personal computer 8 have been translated as described in Embodiment 1. Thus, they cannot be used as they are even when thieved on the delivery path 43, and this method is a method enabling restoration processing on the CPU 2, so that it is not necessary to perform restoration to the update software 4 on the work terminal 41. In Embodiment 2, a CPU for an embedded device having limited memory resources and a limited processing power can perform the restoration, and this method is an effective method as measures against theft or reverse engineering as in Embodiment 1.

### <Hardware Configuration>

Features of the build unit 3, the determination unit 14, the difference generation unit 17, the stored address translation unit 19, the register number translation unit 21, the operand address translation unit 23, the data translation unit 25, the pseudo-code generation unit 27, the pseudo-code insertion unit 29, and the upload unit 7 of the personal computer 8 shown in FIG. 1 are achieved by a processing circuit. That is to say, the personal computer 8 includes a processing circuit to perform processing such as compilation and linkage of the source codes of the software to be updated, determine the update (next inverse translation information 16) performed by the inverse translation processing unit 11 itself when the next software update is performed, generate, from the difference between the current inverse translation information 15 stored in the storage 13 and the next inverse translation information 16 determined by the determination unit 14, the difference update software that is the software to partially update only the difference of the processing performed by the inverse translation processing unit 11, translate the stored address in the update software 18 so that the stored address is restored to the original stored address when being inverse translated according to the current inverse translation information 15, translate the register number in the instruction code of the update software 20 so that the register number is restored to the original register number when being inverse translated according to the current inverse translation information 15, translate the operand address or the immediate data in the instruction code of the update software 22 so that the operand address or the immediate data is restored to the original operand address or the original immediate data when being inverse translated according to the current inverse translation information 15, translate the value of the data in the data region defined by the constant, the structure, and the like in the update software 24 so that the value of the data in the data region is restored to the original value of the data when being inverse translated according to the current inverse translation information 15, generate the instruction code or any data string as the pseudo-code, insert the pseudo-code 28 into the unused stored address in the update software 26, and upload the software (update software 30) after the translation processing generated by the translation processing unit 5 to the update file server 6 via the upload path 9. The processing circuit may be dedicated hardware and may be a processor (also referred to as a CPU, a central processing unit, a processing unit, an arithmetic unit, a microprocessor, a microcomputer, and a digital signal processor (DSP)) that executes a program stored in a memory.

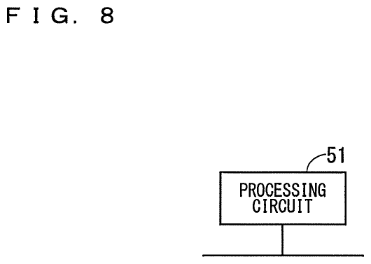

When the processing circuit is the dedicated hardware, a processing circuit 51 corresponds to a single circuit, a composite circuit, a programmed processor, a parallel programmed processor, an application specific integrated circuit (ASIC), a field programmable gate array (FPGA), or a combination thereof, for example, as shown in FIG. 8. Each of the features of the build unit 3, the determination unit 14, the difference generation unit 17, the stored address translation unit 19, the register number translation unit 21, the operand address translation unit 23, the data translation unit 25, the pseudo-code generation unit 27, the pseudo-code insertion unit 29, and the upload unit 7 may be achieved by the processing circuit 51, and the features may collectively be achieved by the single processing circuit 51.

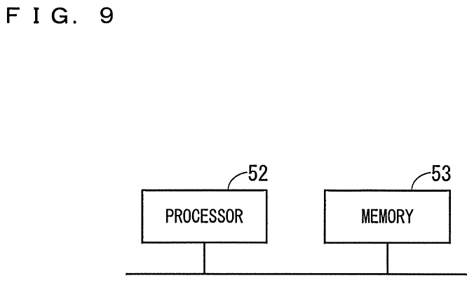

When the processing circuit 51 is a processor 52 shown in FIG. 9, the features of the build unit 3, the determination unit 14, the difference generation unit 17, the stored address translation unit 19, the register number translation unit 21, the operand address translation unit 23, the data translation unit 25, the pseudo-code generation unit 27, the pseudo-code insertion unit 29, and the upload unit 7 are achieved by software, firmware, or a combination of software and firmware. The software or the firmware is described as a program and is stored in a memory 53. The processor 52 reads and executes the program stored in the memory 53 to achieve the features. That is to say, the personal computer 8 includes the memory 53 to store the program which results in performance of steps including: performing processing such as compilation and linkage of the source codes of the software to be updated, determining the update (next inverse translation information 16) performed by the inverse translation processing unit 11 itself when the next software update is performed, generating, from the difference between the current inverse translation information 15 stored in the storage 13 and the next inverse translation information 16 determined by the determination unit 14, the difference update software that is the software to partially update only the difference of the processing performed by the inverse translation processing unit 11, translating the stored address in the update software 18 so that the stored address is restored to the original stored address when being inverse translated according to the current inverse translation information 15, translating the register number in the instruction code of the update software 20 so that the register number is restored to the original register number when being inverse translated according to the current inverse translation information 15, translating the operand address or the immediate data in the instruction code of the update software 22 so that the operand address or the immediate data is restored to the original operand address or the original immediate data when being inverse translated according to the current inverse translation information 15, translating the value of the data in the data region defined by the constant, the structure, and the like in the update software 24 so that the value of the data in the data region is restored to the original value of the data when being inverse translated according to the current inverse translation information 15, generating the instruction code or any data string as the pseudo-code, inserting the pseudo-code 28 into the unused stored address in the update software 26, and uploading the software (update software 30) after the translation processing generated by the translation processing unit 5 to the update file server 6 via the upload path 9. It can be said that the program causes a computer to perform procedures or methods of the build unit 3, the determination unit 14, the difference generation unit 17, the stored address translation unit 19, the register number translation unit 21, the operand address translation unit 23, the data translation unit 25, the pseudo-code generation unit 27, the pseudo-code insertion unit 29, and the upload unit 7. The memory herein may be, for example, a nonvolatile or volatile semiconductor memory, such as a random access memory (RAM), a read only memory (ROM), a flash memory, an erasable programmable read only memory (EPROM), and an electrically erasable programmable read only memory (EEPROM), a magnetic disk, a flexible disk, an optical disc, a compact disc, a digital versatile disc (DVD), and the like or any storage medium to be used in the future.

One or more of the features of the build unit 3, the determination unit 14, the difference generation unit 17, the stored address translation unit 19, the register number translation unit 21, the operand address translation unit 23, the data translation unit 25, the pseudo-code generation unit 27, the pseudo-code insertion unit 29, and the upload unit 7 may be achieved by the dedicated hardware, and the other one or more of the features may be achieved by the software or the firmware.

As described above, the processing circuit can achieve the above-mentioned features by the hardware, the software, the firmware, or a combination of them.

While a hardware configuration of the personal computer 8 in FIG. 1 has been described above, the same applies to a hardware configuration of the embedded device 1 shown in FIG. 1.

Embodiments can freely be combined with each other and can be modified or omitted as appropriate within the scope of the present disclosure.

While the present disclosure has been described in detail, the foregoing description is in all aspects illustrative and not restrictive. It is understood that numerous unillustrated modifications can be devised.

### EXPLANATION OF REFERENCE SIGNS

1 embedded device, 2 CPU, 3 build unit, 4 update software, 5 translation processing unit, 6 update file server, 7 upload unit, 8 personal computer, 9 upload path, 10 download path, 11 inverse translation processing unit, 12 update unit, 13 storage, 14 determination unit, 15 current inverse translation information, 16 next inverse translation information, 17 difference generation unit, 18 update software, 19 stored address translation unit, 20 update software, 21 register number translation unit, 22 update software, 23 operand address translation unit, 24 update software, 25 data translation unit, 26 update software, 27 pseudo-code generation unit, 28 pseudo-code, 29 pseudo-code insertion unit, 30 update software, 31 pseudo-code removal unit, 32 data inverse translation unit, 33 operand address inverse translation unit, 34 register number inverse translation unit, 35 stored address inverse translation unit, 36 difference update unit, 41 work terminal, 42 jig, 43 delivery path, 51 processing circuit, 52 processor, 53 memory.

1.-7. (canceled)

8. A software update system comprising an update software generation device and a central processing unit (CPU), the update software generation device generating update software to update software running on the CPU, the CPU updating the software using the update software generated by the update software generation device, wherein
the update software generation device comprises:
a processor to execute a program; and
a memory to store the program which, when executed by the processor, performs a process of
translating a stored address stored in a memory on the CPU allocated per at least one instruction code of an assembler code or a machine language code of the update software into a different stored address from a normal stored address,
the CPU comprises:
a processor to execute a program; and
a memory to store the program which, when executed by the processor, performs a process of
returning the different stored address resulting from the translation to the normal stored address,
the program stored in the memory of the update software generation device further performs, when executed by the processor, a process of
translating a register number of a general-purpose register for use in an instruction code of an assembler code or a machine language code of the update software into a register number usable by the CPU,
the program stored in the memory of the CPU further performs, when executed by the processor, a process of
returning the register number usable by the CPU resulting from the translation to the register number as an original register number,
the translation into the register number usable by the CPU is performed before or after the translation into the different stored address, and
the register number usable by the CPU is returned to the original register number before or after the return to the normal stored address.

9. The software update system according to claim 8, wherein
the program stored in the memory of the update software generation device further performs, when executed by the processor, a process of
translating a register number of a floating point register for use in an instruction code of an assembler code or a machine language code of the update software into a register number usable by the CPU.

10. The software update system according to claim 8, wherein
the program stored in the memory of the update software generation device further performs, when executed by the processor, a process of
translating a stored address stored in the memory allocated per data in a data region defined at least by a constant and a structure in the update software into a different stored address from a normal stored address.

11. The software update system according to claim 8, wherein
the program stored in the memory of the update software generation device further performs, when executed by the processor, processes of:
generating an instruction code or a data string of an assembler code or a machine language code of the update software as a pseudo-code; and
inserting the generated pseudo-code into an unused stored address in the update software or into a stored address that is no longer used by being translated into the different stored address,
the program stored in the memory of the CPU further performs, when executed by the processor, a process of
removing the inserted pseudo-code,
the pseudo-code is inserted before or after the translation into the different stored address, and
the pseudo-code is inserted before or after the return to the normal stored address.

12. The software update system according to claim 8, wherein
the program stored in the memory of the update software generation device further performs, when executed by the processor, a process of
translating an operand address or immediate data for use in an instruction code of an assembler code or a machine language code of the update software,
the program stored in the memory of the CPU further performs, when executed by the processor, a process of
returning an operand address or immediate data resulting from the translation to the operand address or the immediate data as an original operand address or original immediate data,
the operand address or the immediate data is translated before or after the translation into the different stored address, and
the return to the original operand address or the original immediate data is performed before or after the return to the normal stored address.

13. The software update system according to claim 8, wherein
the program stored in the memory of the update software generation device further performs, when executed by the processor, a process of
translating a value of each piece of data in the data region defined at least by the constant and the structure in the update software,
the program stored in the memory of the CPU further performs, when executed by the processor, a process of
returning data resulting from the translation to the data as original data,
the value of the data is translated before or after the translation into the different stored address, and
the return to the original data is performed before or after the return to the normal stored address.

14. The software update system according to claim 8, wherein
the program stored in the memory of the update software generation device further performs, when executed by the processor, processes of:
storing current processing performed by the program stored in the memory of the CPU;
determining new processing performed by the program stored in the memory of the CPU; and
generating difference update software to partially update only a difference between the stored current processing and the determined new processing and merging the difference update software into the update software, and
the program stored in the memory of the CPU further performs, when executed by the processor, a process of
removing the merged difference update software for return to the update software as original update software.

15. A software update method for use in a software update system including an update software generation device and a central processing unit (CPU), the update software generation device generating update software to update software running on the CPU, the CPU updating the software using the update software generated by the update software generation device, the software update method comprising:
translating a stored address stored in a memory on the CPU allocated per at least one instruction code of an assembler code or a machine language code of the update software into a different stored address from a normal stored address:
returning the different stored address resulting from the translation to the normal stored address:
translating a register number of a general-purpose register for use in an instruction code of an assembler code or a machine language code of the update software into a register number usable by the CPU; and
returning the register number usable by the CPU resulting from the translation to the register number as an original register number, wherein
the translation into the register number usable by the CPU is performed before or after the translation into the different stored address, and
the register number usable by the CPU is returned to the original register number before or after the return to the normal stored address.
